(19) United States
(12) Patent Application Publication
(10) Pub. No.: US 2016/0126045 A1
(43) Pub. Date: May 5, 2016

(54) MEMS SWITCH AND METHOD OF MANUFACTURING THE SAME

(71) Applicant: Samsung Electro-Mechanics Co., Ltd., Suwon-si (KR)

(72) Inventor: Seong Jong CHEON, Suwon-si (KR)

(73) Assignee: Samsung Electro-Mechanics Co., Ltd., Suwon-si (KR)

(21) Appl. No.: 14/864,455

(22) Filed: Sep. 24, 2015

(30) Foreign Application Priority Data
Nov. 3, 2014 (KR) 10-2014-0150922

(51) Int. Cl. H01H 59/00; H01H 49/00

(52) U.S. Cl. CPC H01H 59/0009; H01H 49/00

(57) ABSTRACT

A microelectromechanical systems (MEMS) switch includes: a signal line disposed on a substrate; a dielectric member attached to the substrate; support fixtures disposed on the substrate at opposing sides of the signal line; and a membrane having ends fixed to the support fixtures, and a protrusion-recess pattern having a corrugated structure, the membrane being configured to change a capacitance provided by the membrane and the dielectric member by being positioned adjacent to the dielectric member through a downward movement.

### CROSS-REFERENCE TO RELATED APPLICATION(S)

This application claims the benefit of Korean Patent Application No. 10-2014-0150922 filed on Nov. 3, 2014, in the Korean Intellectual Property Office, the entire disclosure of which is incorporated herein by reference for all purposes.

### BACKGROUND

1. Field

The following description relates to a microelectromechanical systems (MEMS) switch and a method of manufacturing the same.

2. Description of Related Art

Microelectromechanical systems (MEMS) relate to a technology in which micro switches, mirrors, sensors, precision machine parts, and the like are machined using semiconductor machining technology.

Therefore, MEMS has been recognized as a technology capable of improving performance while reducing the price of semiconductor technology products through features such as precise machinability, product uniformity, excellent productivity, and the like.

Among devices using MEMS technology, the devices that are currently the most widely manufactured devices are MEMS switches. A MEMS switch is a device which is commonly used for the selective transmission of microwave or millimeter wave band signals in a radio communications terminal, an impedance matching circuit, or the like. An example of a MEMS switch is disclosed in Korean Patent Laid-Open Publication No. 2011-011.

In addition, since a MEMS switch for radio frequency (RF) signal control may have advantages such as low power consumption, excellent isolation characteristics, low insertion loss, low inter-modulation, and price competitiveness, a large amount of research into MEMS switches has been conducted.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a microelectromechanical systems (MEMS) switch may include: a signal line disposed on a substrate; a dielectric member attached to the signal line; support fixtures disposed on the substrate at opposing sides of the signal line; and a membrane having opposing ends fixed to the support fixtures, and a protrusion-recess pattern having a corrugated structure, the membrane being configured to change a capacitance provided by the membrane and the dielectric member by being positioned adjacent to the dielectric member through a downward movement.

The protrusion-recess pattern may include a plurality of protrusions and recesses.

A number of protrusions and recesses of the protrusion-recess pattern may be determined based on a direct current (DC) voltage applied to the signal line and a limit of elasticity of the membrane.

The membrane may be configured to move closer to the dielectric member by the downward movement as a direct current (DC) voltage applied to the signal line is increased.

The capacitance provided by the membrane and the dielectric member may be increased as a direct current (DC) voltage applied to the signal line is increased.

The membrane may be connected to a ground through the support fixtures.

A radio frequency (RF) signal passing through the signal line may be induced to a ground as the capacitance is increased.

The protrusion-recess pattern may include two pattern portions disposed on opposing sides of the membrane.

According to another general aspect, a method of manufacturing a microelectromechanical systems (MEMS) switch may include: forming a signal line on a substrate; forming support fixtures on the substrate at opposing sides of the signal line and depositing a dielectric member on a surface of the signal line; forming a sacrificial layer between the support fixtures and on the dielectric member, and patterning a step portion in the sacrificial layer to form a protrusion-recess pattern; forming a membrane on the support fixtures and the sacrificial layer; and removing the sacrificial layer.

The substrate may include one of silicon, sapphire, gallium arsenide (GaAs), quartz, a printed circuit board (PCB), and low temperature co-fired ceramic (LTCC).

The signal line and the support fixtures may be formed by performing one of a cell electroplating method, an electroless plating method, a sputtering method, and a chemical vapor deposition (CVD) method for one of metal and oxide electrodes.

The dielectric member may include at least one of silicon nitride (SiₓN_{y}), lead zirconate titanate (PZT), silicon dioxide (SiO₂), and aluminum nitride (AlN).

The sacrificial layer may be formed of a polymer based material, and the step portion of the protrusion-recess pattern is patterned by a dual exposure method.

The sacrificial layer may be formed by plating a metal based material, and the step portion of the protrusion-recess pattern may be patterned by a dual plating method.

The sacrificial layer may be removed by one of a dry etching method and a wet etching method.

The protrusion-recess pattern may form two pattern portions disposed on opposing sides of the membrane.

Other features and aspects will be apparent from the following detailed description, the drawings, and the claims.

### BRIEF DESCRIPTION OF DRAWINGS

FIG. 1 is a perspective view schematically illustrating an example of a MEMS switch.

FIG. 2 is a perspective view illustrating another example of a MEMS switch.

FIG. 3 is a perspective view illustrating a short state in the MEMS switch of FIG. 2.

FIG. 4 is a diagram illustrating an example method of manufacturing a MEMS switch.

FIG. 5 is a diagram illustrating an example process of forming a sacrificial layer of the method of FIG. 4.

FIG. 6 is a diagram illustrating another example process of forming a sacrificial layer of the method of FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

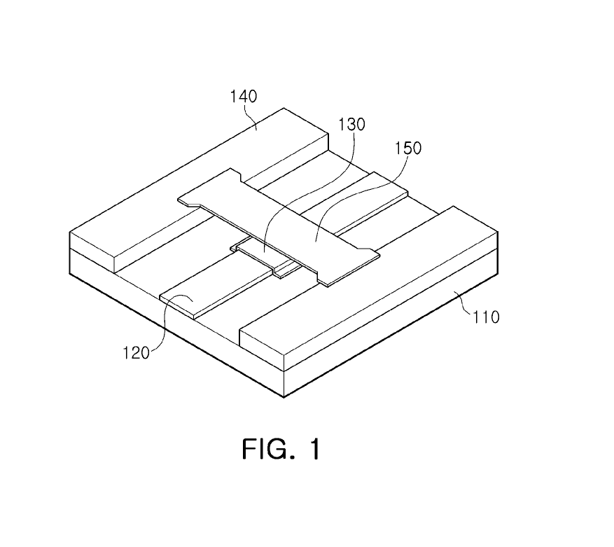

FIG. 1 is a perspective view schematically illustrating a MEMS switch 100 according to an example.

Referring to FIG. 1, the MEMS switch 100 includes a substrate 110, a signal line 120 disposed on the substrate 110 and having a dielectric member 130 attached thereto, support fixtures 140 disposed on the substrate 110 at opposing sides of the signal line 120, and a membrane 150 having both ends thereof fixed to the support fixtures 140.

The signal line 120 is disposed on the substrate 100 to provide a path for an RF signal and the dielectric member 130 may be attached to the signal line 120 at a predetermined portion thereof.

The predetermined portion at which the dielectric member 130 is attached to the signal line 120 may correspond to an overlapped area of the membrane 150 and the signal line 120.

Hereinafter, an operation of the MEMS switch 100 will be described with reference to FIG. 1.

In a case in which a direct current (DC) voltage is applied to the signal line 120, an electrical field is generated between the signal line 120 and the membrane 150.

The membrane 150 may be moved downwardly by electrostatic force due to the electrical field formed by the DC voltage applied to the signal line 120.

Here, as the DC voltage is increased, the downward movement of the membrane 150 may increase, which may cause the membrane 150 to be positioned adjacent to the dielectric member 130. As a result, capacitance formed by the membrane 150 and the dielectric member 130 may increase.

Meanwhile, the membrane 150 may be connected to a ground through the support fixtures 140.

When the operating state described above is a short state in the MEMS switch 100, the MEMS switch 100 may induce the RF signal passing through the signal line 120 to the ground as capacitance is increased.

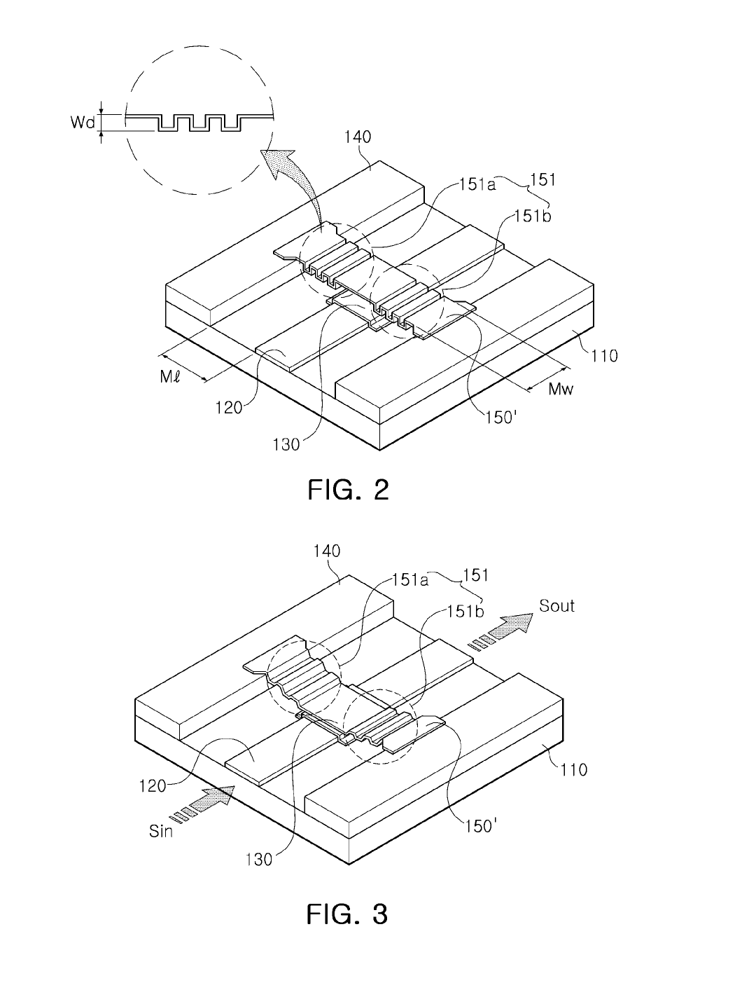

FIG. 2 is a perspective view illustrating a MEMS switch 200 according to another example.

Referring to FIG. 2, the MEMS switch 200 includes a substrate 110, a signal line 120 disposed on the substrate 110 and having a dielectric member 130 attached thereto, support fixtures 140 disposed on the substrate 110 at opposing sides of the signal line 120, and a membrane 150′ having both ends fixed to the support fixtures 140. The membrane 150′ is similar to the membrane 150 in FIG. 1, except that the membrane 150′ includes a protrusion-recess pattern 151 having a corrugated structure.

The signal line 120 is disposed on the substrate 100 to provide a path for an RF signal and the dielectric member 130 may be attached to the signal line 120 at a predetermined portion thereof.

In a case in which only an RF signal is applied to the signal line 120 and a DC voltage is not applied to the signal line 120, capacitance formed by the membrane 150′, which is not moved downwardly, and the dielectric member 130 may exhibit numerical values (e.g., tens fF) which do not have influence on the RF signal passing through the signal line 120.

As a result, the RF signal may be transferred from an input of the MEMS switch 200 to an output thereof without loss.

On the other hand, in the short state in which the DC voltage is applied to the signal line 120, an electrical field may be generated between the signal line 120 and the membrane 150′. The membrane 150′ may be moved downwardly by electrostatic force due to the electrical field formed by the DC voltage applied to the signal line 120.

The protrusion-recess pattern 151 may include a first protrusion-recess pattern 151a and a second protrusion-recess pattern 151b, and the first protrusion-recess pattern 151a and the second protrusion-recess pattern 151b may each include a plurality of protrusions and recesses. The first and second protrusion-recess patterns 151a and 151b may be formed at opposing sides of the signal line 120. A spring constant of the membrane 150′ may be reduced by the protrusion-recess pattern 151 due to the plurality of protrusions and recesses.

As the DC voltage is increased, the downward movement of the membrane 150′ may increase, causing the membrane 150′ to be positioned adjacent to the dielectric member 130. The membrane 150′ may be driven at a low voltage according to the reduced spring constant provided by the protrusion-recess pattern 151. More specifically, reducing the spring constant of the membrane 150′ through inclusion of the protrusion-recess pattern 151 enables the membrane 150′ to be driven at a lower voltage.

Meanwhile, the capacitance provided by the membrane 150′ and the dielectric member 130 may be increased according to an overlapped area of the membrane 150 and the signal 120, and a dielectric constant of the dielectric member 130, and the predetermined portion in which the dielectric member 130 is attached to the signal line 120 may be determined by taking account of the overlapped area of the membrane 150 and the signal line 120.

In addition, the membrane 150′ may be connected to a ground through the support fixtures 140.

When the operating state described above is a short state in the MEMS switch 200, the MEMS switch 200 may induce the RF signal passing through the signal line 120 to flow to the ground as capacitance is increased. More specifically, the MEMS switch 200 may be operated in the short state in which the RF signal is induced to the ground at the low driving voltage.

FIG. 3 is a perspective view illustrating a short state in the MEMS switch 200 according to an example.

Referring to FIG. 3, at the time of the short state in the MEMS switch, a signal S_{IN} input to the signal line 120 may be an RF signal or a DC voltage. The membrane 150 may be connected to the ground through the support fixtures 140, and may provide capacitance together with the dielectric member 130 at the time of the short state. Therefore, the RF signal input to the signal line 120 may be induced to the ground according to the capacitance, and a signal S_{OUT} output from the signal line 120 may not include the RF signal.

In this case, since the membrane 150′ has a low spring constant, the membrane 150′ may be driven at a low voltage.

Hereinafter, examples of short state driving depending on the number of protrusions and recesses in the protrusion recess pattern 151 will be described with reference to FIGS. 2 and 3.

According to an example, the protrusion-recess pattern 151a or 151b of one side of the membrane 150′ may have a length Mₗ (FIG. 2) of 150 μm, a width M_{w} (FIG. 2) of 15 μm, and a step portion height W_{d} (FIG. 2) of 0.7 μm. The step portion height W_{d} is the height of the protrusions and recesses.

The disclosure is not limited to the example numerical values provided for the aforementioned dimensions, and these numerical values may be adjusted depending on the design as an assumption for illustrating a change in a driving voltage depending on the number of protrusions and recesses.

In a case in which one protrusion and recess pattern is formed in each of the first protrusion-recess pattern 151a and the second protrusion-recess pattern 151b, the MEMS switch 200 may have a driving voltage of about 45V.

In a case in which two protrusion and recess patterns are formed in each of the first protrusion-recess pattern 151a and the second protrusion-recess pattern 151b, the MEMS switch 200 may have a driving voltage of about 37V.

In a case in which three protrusion and recess patterns are formed in each of the first protrusion-recess pattern 151a and the second protrusion-recess pattern 151b, the MEMS switch 200 may have a driving voltage of about 25V.

Accordingly, as the number of protrusions and recesses included in the protrusion-recess pattern 151 is increased, the MEMS switch 200 may be driven at a lower voltage.

Therefore, the number of protrusions and recesses of the protrusion-recess pattern 151 may be determined based on the DC voltage applied to the signal line 120 and a limit of elasticity of the membrane 150′.

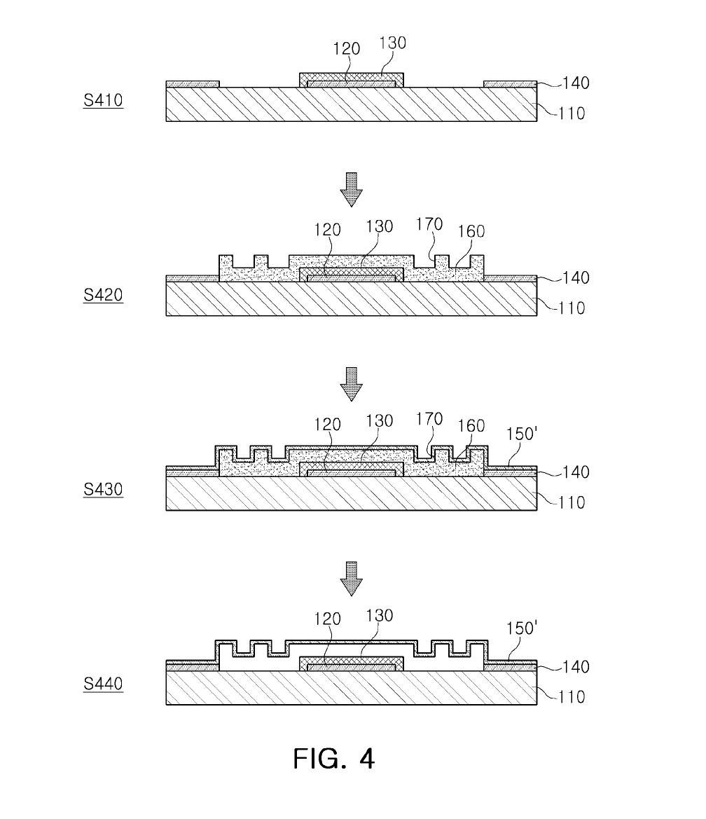

FIG. 4 is a diagram illustrating a method of manufacturing a MEMS switch according to an example.

Referring to FIG. 4, in operation S410, the signal line 120 and the support fixtures 140 on both sides of the signal line 120 are formed on the substrate 110, and the dielectric member 130 is deposited on the surface of the signal line 120.

Next, in operation S420, a sacrificial layer 160 is formed between the support fixtures 140 and on the dielectric member 130, and a step portion 170 to form a protrusion-recess pattern is patterned.

Next, in operation S430, a membrane 150′ is formed on the support fixtures 140 and the sacrificial layer 160 in operation S430, and the sacrificial layer 160 is then removed in operation S440.

The substrate may include one of silicon, sapphire, gallium arsenide (GaAs), quartz, a printed circuit board (PCB), and low temperature co-fired ceramic (LTCC).

The signal line 120 and the support fixtures 140 may be formed by performing one of a cell electroplating method, an electroless plating method, a sputtering method, and a chemical vapor deposition (CVD) method for one of metal and oxide electrodes.

In addition, the dielectric member 130 may include, for example, at least one of silicon nitride (SiₓN_{y}), lead zirconate titanate (PZT), silicon dioxide (SiO₂), and aluminum nitride (AlN).

The sacrificial layer 160 may, for example, be formed of a metallic material or a polymer based material which may be etched, as well as a poly-silicon based material.

The sacrificial layer may be removed, for example, by one of a dry etching method and a wet etching method.

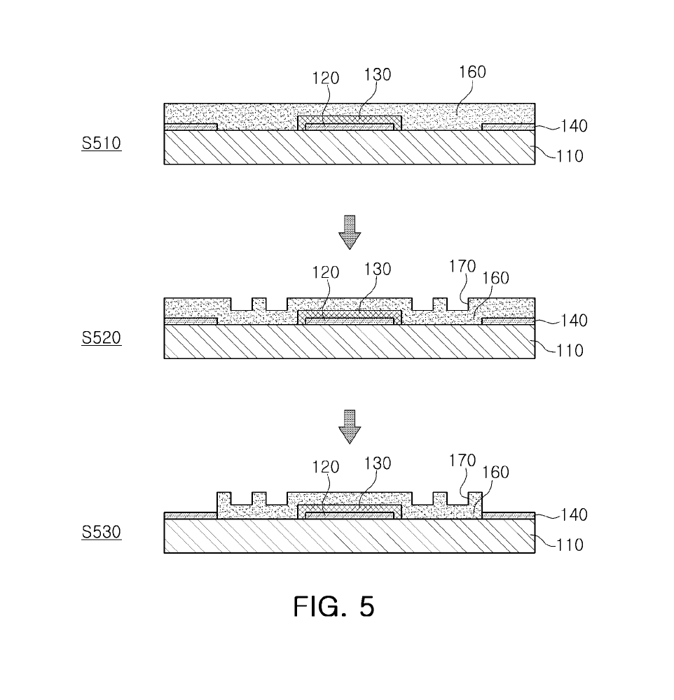

FIG. 5 is a diagram illustrating a process of forming the sacrificial layer 160.

As described above with reference to FIG. 4, the sacrificial layer 160 is formed between the support fixtures 140 and on the dielectric member 130 (operation S430).

Referring to FIG. 5, the sacrificial layer 160 is formed of a polymer based material, and the step portions 170 of the protrusion-recess pattern 151 is patterned by a dual exposure method. Hereinafter, the dual exposure method for patterning the step portions 170 will be described.

First, in operation S510, the polymer based material is applied to the support fixtures 140 and the dielectric member 130 formed on the substrate 110. Then, in operation S520, step portions 170 forming the protrusion-recess pattern 151 (FIG. 2) having a corrugated structure are patterned using a photolithography process.

Next, in operation S530, the polymer applied on the support fixtures 140 is removed so that the membrane 150 may be connected to the support fixtures 140 upon forming the membrane 150′.

As a result, the sacrificial layer 160 is formed with the step portions 170 patterned therein.

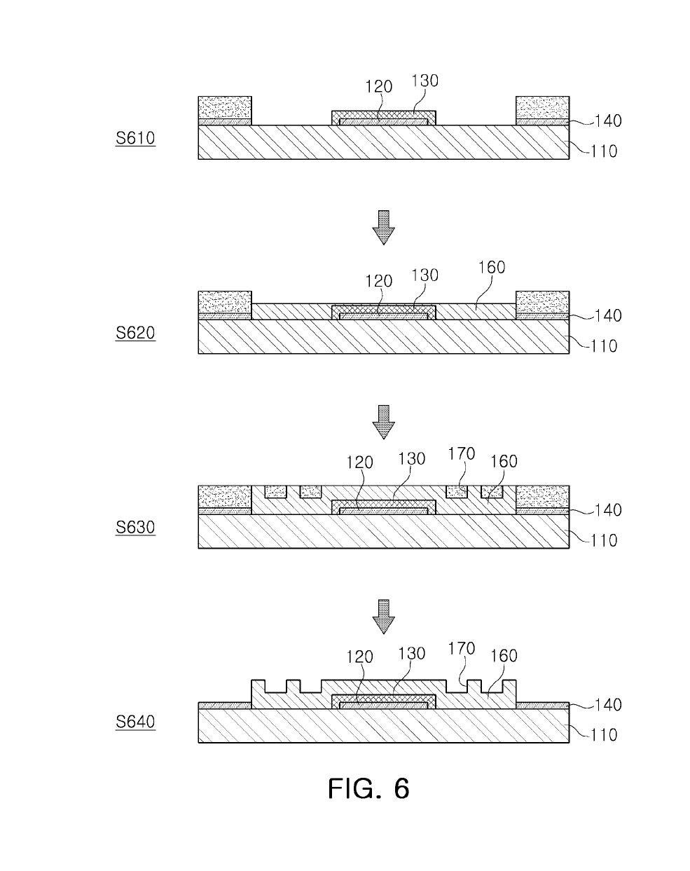

FIG. 6 is a diagram illustrating a process of forming the sacrificial layer 160 according to another example.

As described above with reference to FIG. 4, the sacrificial layer 160 is formed between the support fixtures 140 and on the dielectric member 130 (operation S430).

Referring to FIG. 6, the sacrificial layer 160 is formed by plating a metal based material, and the step portions 170 of the protrusion and recess pattern 151 are patterned by a dual plating method.

Hereinafter, the dual plating method will be described.

First, in operation S610, the polymer based material is applied to the support fixtures 140 and the dielectric member 130 formed on the substrate 110. The polymer applied between the support fixtures 140 is then removed in operation S610 for performing a plating process.

After the polymer applied between the support fixtures 140 is removed, a primary plating process is performed between the support fixtures 140 and on the dielectric member 130 in operation S620.

Next, in operation S630, the polymer based material is applied on a primary plated portion to pattern the step portions 170 of the protrusion-recess pattern 151, and a secondary plating process is performed after the step portions 170 are patterned (S630).

Next, the polymer left on the dual plated sacrificial layer is removed in operation S640.

As a result, the sacrificial layer 160 is formed with the step portions 170 of the protrusion-recess pattern 151 patterned therein.

As set forth above, according to the disclosed examples, a MEMS switch may be driven at a low voltage while having a reduced spring constant.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A microelectromechanical systems (MEMS) switch comprising:
a signal line disposed on a substrate;
a dielectric member attached to the signal line;
support fixtures disposed on the substrate at opposing sides of the signal line; and
a membrane comprising ends fixed to the support fixtures, and a protrusion-recess pattern having a corrugated structure, the membrane being configured to change a capacitance provided by the membrane and the dielectric member by being positioned adjacent to the dielectric member through a downward movement.

2. The MEMS switch of claim 1, wherein the protrusion-recess pattern includes a plurality of protrusions and recesses.

3. The MEMS switch of claim 1, wherein a number of protrusions and recesses of the protrusion-recess pattern is determined based on a direct current (DC) voltage applied to the signal line and a limit of elasticity of the membrane.

4. The MEMS switch of claim 1, wherein the membrane is configured to move closer to the dielectric member by the downward movement as a direct current (DC) voltage applied to the signal line is increased.

5. The MEMS switch of claim 1, wherein the capacitance provided by the membrane and the dielectric member is increased as a direct current (DC) voltage applied to the signal line is increased.

6. The MEMS switch of claim 1, wherein the membrane is connected to a ground through the support fixtures.

7. The MEMS switch of claim 1, wherein a radio frequency (RF) signal passing through the signal line is induced to a ground as the capacitance is increased.

8. The MEMS switch of claim 1, wherein the protrusion-recess pattern comprises two pattern portions disposed on opposing sides of the membrane.

9. A method of manufacturing a microelectromechanical systems (MEMS) switch, the method comprising:
forming a signal line on a substrate;
forming support fixtures on the substrate at opposing sides of the signal line and depositing a dielectric member on a surface of the signal line;
forming a sacrificial layer between the support fixtures and on the dielectric member, and patterning a step portion in the sacrificial layer to form a protrusion-recess pattern;
forming a membrane on the support fixtures and the sacrificial layer; and
removing the sacrificial layer.

10. The method of claim 9, wherein the substrate includes one of silicon, sapphire, gallium arsenide (GaAs), quartz, a printed circuit board (PCB), and low temperature co-fired ceramic (LTCC).

11. The method of claim 9, wherein the signal line and the support fixtures are formed by performing one of a cell electroplating method, an electroless plating method, a sputtering method, and a chemical vapor deposition (CVD) method for one of metal and oxide electrodes.

12. The method of claim 9, wherein the dielectric member includes at least one of silicon nitride (SiₓN_{y}), lead zirconate titanate (PZT), silicon dioxide (SiO₂), and aluminum nitride (AlN).

13. The method of claim 9, wherein the sacrificial layer is formed of a polymer based material, and the step portion of the protrusion-recess pattern is patterned by a dual exposure method.

14. The method of claim 9, wherein the sacrificial layer is formed by plating a metal based material, and the step portion of the protrusion-recess pattern is patterned by a dual plating method.

15. The method of claim 9, wherein the sacrificial layer is removed by one of a dry etching method and a wet etching method.

16. The method of claim 9, wherein the protrusion-recess pattern forms two pattern portions disposed on opposing sides of the membrane.
